(19) United States
(12) Patent Application Publication
(10) Pub. No.: US 2016/0213198 A1
(43) Pub. Date: Jul. 28, 2016

(54) Battery Powered Portable Electric Grill

(71) Applicant: Clint Adam Smith, Tucson, AZ (US)

(72) Inventor: Clint Adam Smith, Tucson, AZ (US)

(21) Appl. No.: 14/604,749

(22) Filed: Jan. 25, 2015

(51) Int. Cl. A47J 37/07

(52) U.S. Cl. CPC A47J 37/0763

(57) ABSTRACT

Battery powered portable electric grill is an electric grill for cooking food. The system will include dual heating elements with a lid and basin, attached to a battery. Rechargeable batteries and an AC or cigarette lighter receptacle cable powers the heating elements to allow for greater ease of use. The heating elements will be contained within an entire grilling system and stand on wheels for maximum portability.

### CROSS-REFERNECE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF THE MATERIAL ON THE COMPACT DISC:

Not Applicable.

### BACKGROUND OF THE INVENTION

1. Field of the Invention

The present invention generally relates to grilling equipment, and, or more particularly an electric grill.

2. Description of Related Art

Grilling has always had an amount of risk involved. This is due to the hazards of working with fire. Users run the risk of burning themselves or others in the area, which can be extremely dangerous when using fire propellants. Users burn charcoal or use propane or gas in order to cook their food. The difficulty involved in cooking food this way increases drastically in inclement weather. Wind will blow the propane preventing the fire from staying lit, it will also blow the fire out when using charcoal. Rain will dampen the charcoal and prevent it from ever being lit or will put it out if it is already on fire. With this current way of grilling users are limited to cooking in perfect weather. Even electric grills are limited to areas with outlet accessibility. Thus the use of a portable electric grill will allow users to grill inside or outside, in any weather, at anytime with ease.

### BRIEF SUMMARY OF THE INVENTION

The Portable electric grill will replace any gas, charcoal, propane, or other electric grill. It is comprised of fully housed dual heating elements connected to a battery. When connected to an electrical outlet the battery will charge while powering the heating elements. When an electrical outlet is not available the battery will provide power for an extended period of time.

Electric heating elements are not dependent on fire to cook food, therefore they eliminate many hazards caused by charcoal, fire propellants or propane. They can also be used in any weather without disruption to their function. Rain will evaporate on contact with the element. Regardless of wind speed the cooking element will remain hot and ready for use.

Accordingly, the invention presents a unique, convenient way for users to outdoor or indoor grill without the dangers and difficulties involved with conventional means of grilling, as well as not be limited to electrical outlet use. A user need only take his cooking element to the desired location and start grilling using either an electrical outlet or just the battery power. This technology will allow users to fulfill all their grilling needs with a safer and much more reliable means.

### BRIEF DESCRIPTION OF THE SEVERAL VIEWS OF THE DRAWING

FIG. 1 is a bird's eye view of a battery powered portable electric grill, with the lid open.

FIG. 2 is a front view of a battery powered portable electric grill in the upright position.

FIG. 3 is back view of a battery powered portable electric grill in the upright position.

FIG. 4 is a front view of a battery powered portable electric grill in the collapsed position.

FIG. 5 is a bird's eye view of a battery powered electric grill with the lid open and the grills removed to show the heating elements.

### DETAILED DESCRIPTION OF THE INVENTION

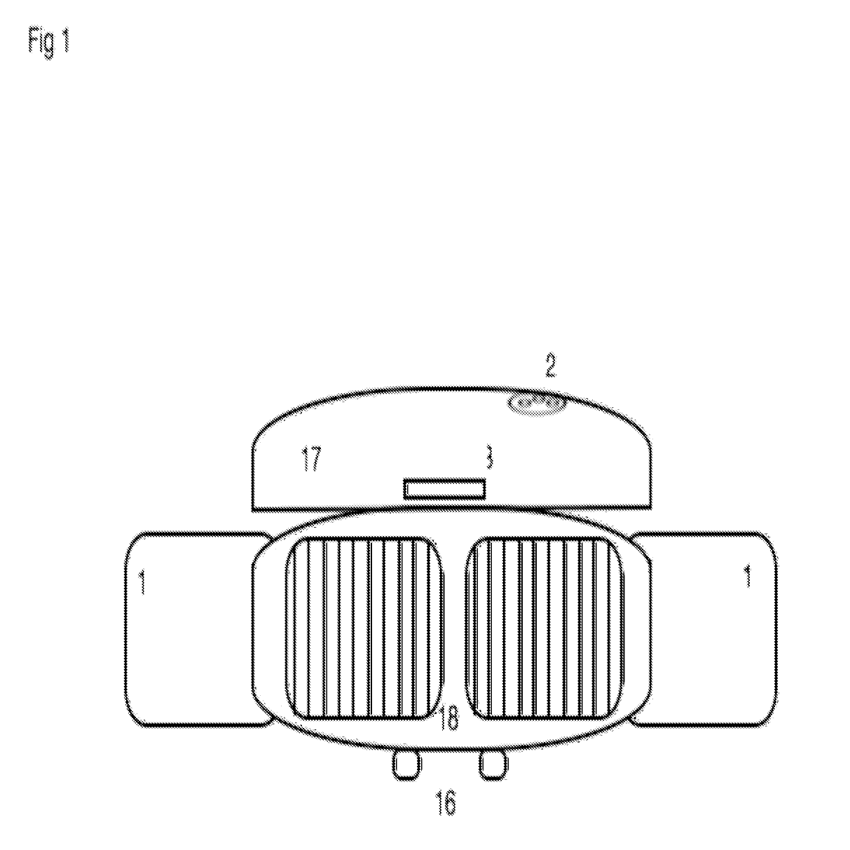

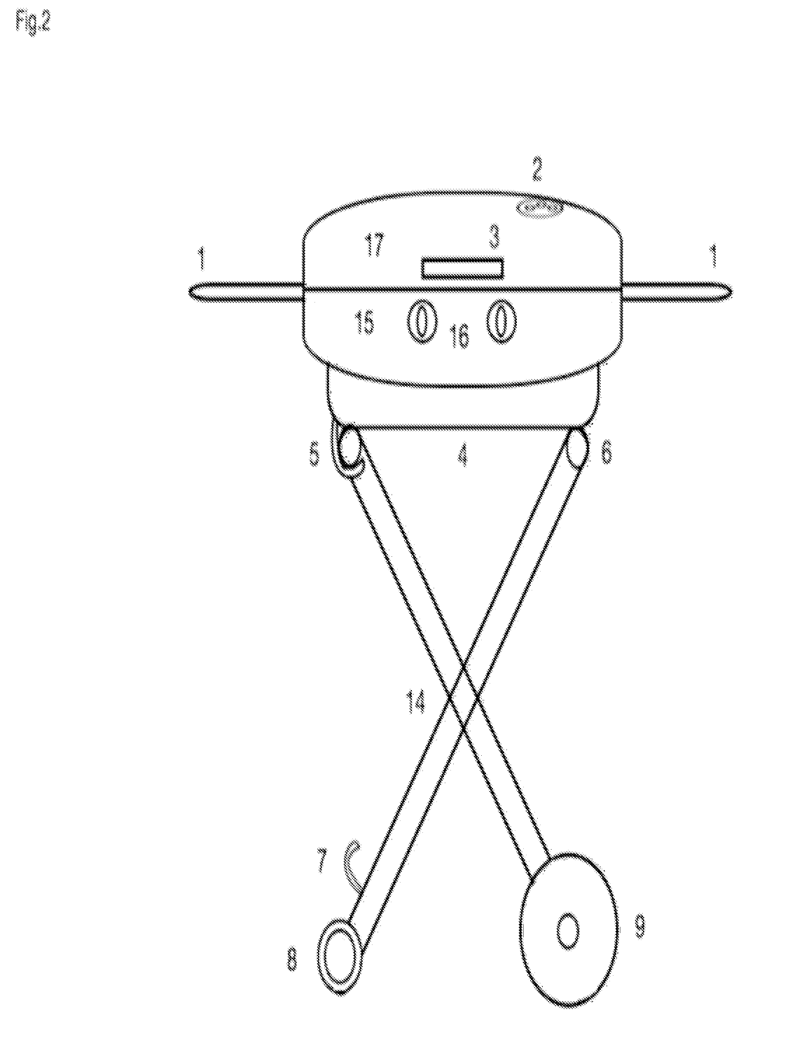

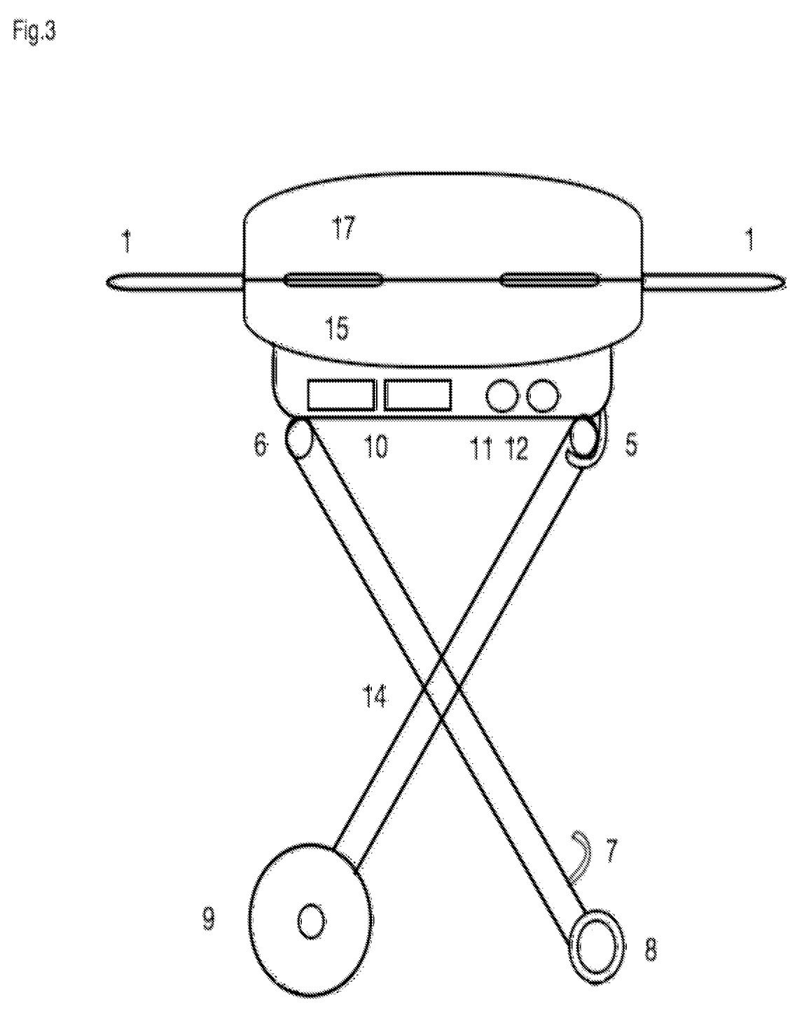

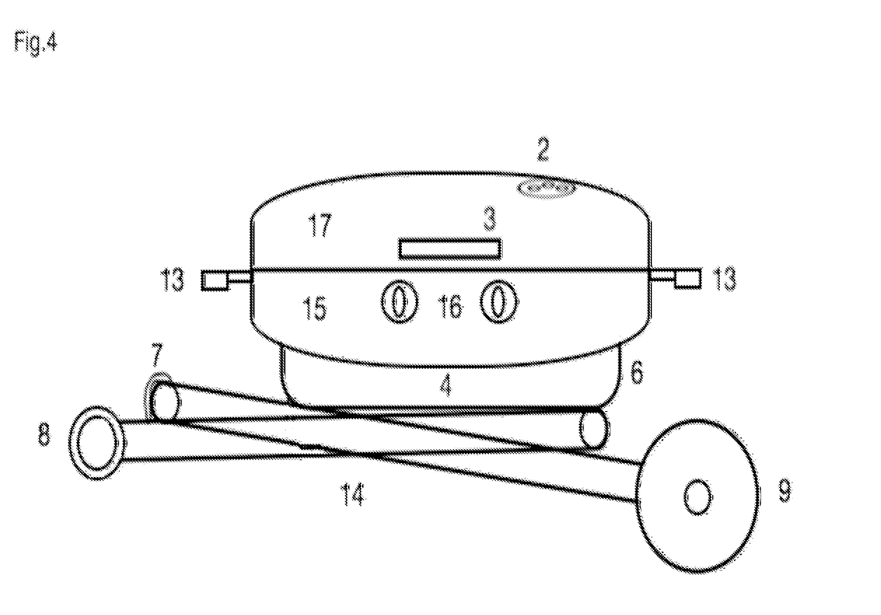

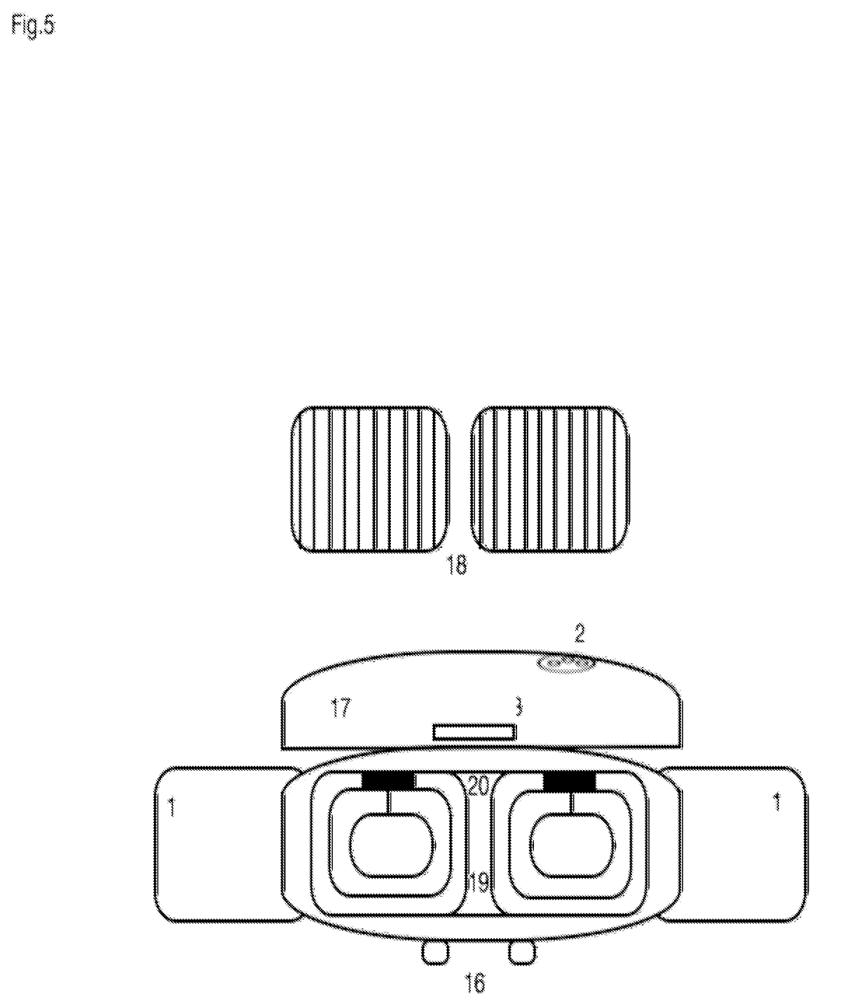

Referring to FIGS. 1-5, for the battery powered portable electric grill. There will be two wheels (9) attached to the bottom of a cross section of the grill stand. The top part of the section will attach when in the upright position to an adapter point (5) on the grill. The adapter (5) will allow this section of the leg stand to detach from the battery compartment (4) allowing both cross sections to move into the collapsed position and lay flat along the bottom of it. When in this position the top of the cross section will lock in the adapter point (7) on the opposite section for more secure transportation. On the bottom of the other cross section there will be rubber-lined feet (8) running parallel to the ground for use as handles when collapsed and a leg stand in the upright position. The cross sections will be joined at a point (14) on the upper half of their length to allow the wheels (9) as well as the rubber handles (8) to clear the outside of the grill during transportation. It will have two trays on each side (1) that attach to adapter points (13). When not in use each tray (1) will fold into the inside of the grill for portability. The adapter points (13) can then be used as handles. On the underside of the grill will be a battery compartment (4), which will house the batteries (10), an AC power outlet and cord (11) and a car cigarette lighter receptacle and cord (12). When plugged in either cord (11), (12) will charge the batteries (10) and power the electric heating elements (19). The grills (18) and the heating elements (19) will be able to be dethatched from the basin (15) for easy cleaning. The basin (15) will also contain the temperature control knobs (16) for each electric heating element (19). The heating elements (19) connect to the batteries (10) at a connection point (20) and will heat up the grills (18) in order to cook food evenly. The lid (17) will contain an adjustable smoke vent (2) for airflow as well as a handle (3) for operating.

I claim:

1. The battery powered portable electric grill consisting of: fully housed dual heating elements with temperature controls, for use with grilling and cooking food, that will be powered through the use of batteries, for greater safety, ease of use, and portability, or powered with an AC cable connecter or a car cigarette lighter receptacle, for use wen available; the power cable will then charge the batteries and power the heating elements for cooking, to be applied to all forms of future and current grills requiring electricity.
